(19) United States
(12) Patent Application Publication
(10) Pub. No.: US 2026/0040419 A1
(43) Pub. Date: Feb. 5, 2026

(54) METHOD AND SYSTEM FOR ILLUMINATING PLANTS WITH ARTIFICIAL LIGHT

(71) Applicant: SIGNIFY HOLDING B.V., EINDHOVEN (NL)

(72) Inventors: MARCELLINUS PETRUS CAROLUS MICHAEL KRIJN, EINDHOVEN (NL); LEONIE MARIA GEERDINCK, EINDHOVEN (NL); SILVIA MARIA BOOIJ, EINDHOVEN (NL); LAMBERTUS ADRIANUS MARINUS DE JONG, SON (NL); MAURICE ALEXANDER HUGO DONNERS, WAALRE (NL); LAMBERTUS ANTONIUS JOHANNES VAN DE WIJDEVEN, SINT OEDENRODE (NL); ERIK PIETER ARNOLD STAPPERS, EINDHOVEN (NL)

(21) Appl. No.: 19/099,075

(22) PCT Filed: Jul. 25, 2023
(86) PCT No.: PCT/EP2023/070516

§ 371 Date: Jan. 28, 2025

(30) Foreign Application Priority Data
Jul. 29, 2022 (EP) 22187699.8

(51) Int. Cl. H05B 47/11; A01G 7/04

(52) U.S. Cl. CPC H05B 47/11; A01G 7/045

(57) ABSTRACT

A computer-implemented method is disclosed for controlling one or more luminaires that are configured to illuminate one or more plants with artificial light. The artificial light comprises a plurality of artificial light components. Each of the artificial light components is of a respective wavelength or wavelength range. The plurality of artificial light components comprises a first artificial light component of a first wavelength or wavelength range and a second artificial light component of a second wavelength or wavelength range. Further, sunlight is incident on the one or more plants. The sunlight comprises a plurality of sunlight components. Each of the sunlight components is of a respective wavelength or wavelength range. The plurality of sunlight components comprising a first sunlight component of the first wavelength or wavelength range and a second sunlight component of the second wavelength or wavelength range. The method comprises receiving a signal indicative of a non-spectrally resolved irradiance value of sunlight that is incident on the one or more plants.

### FIELD OF THE INVENTION

This disclosure relates to a method and system for illuminating one or more plants with artificial light. In particular to such a method and system, a signal is involved indicative of a non-spectrally resolved irradiance value of at least one of:
sunlight that is incident on the one or more plants,
artificial light that is to be incident on the one or more plants. This disclosure further relates to a computer program and computer-readable storage medium and controller for performing such method.

### BACKGROUND OF THE INVENTION

To allow for year-round production of crops in greenhouses, such as tomato, many growers nowadays use supplemental lighting, such as LED lighting, especially during the autumn, winter, and spring, when daylight levels are in general insufficient for tomato growth (in northern countries) and tomato prices are high.

The supplemental lighting, also more generally referred to as artificial light, can be applied above the canopy of plants (so-called top-lighting) or from within the canopy of plants (so-called inter-lighting).

Plants use light as the energy source for assimilating CO2 from the ambient air and converting it into biomass. This process is called photosynthesis. Part of the biomass is partitioned to the fruits (such as tomatoes). Light is therefore essential for plant and fruit growth. In modern greenhouses, environmental parameters such as climate and irrigation are well under control, meaning that the availability of light is the factor limiting growth.

The process of photosynthesis takes place primarily for light within a range of wavelengths. This range is roughly from 400-700 nm. The radiation within this range is called photosynthetically-active-radiation (PAR).

The PAR light level is expressed in μmol/s/m², where 1 mole of light corresponds to a number of photons equal to Avogadro's number (6.0×10²³).

Artificial lighting in horticulture consumes energy, resulting in an operational cost that is substantial and resulting in a non-negligible carbon footprint in case electricity generated from fossil fuels is used. It is therefore desired to reduce energy consumption.

US 2016/0088802 a lighting system and method for the growing of a plant seedling, including at least one light source for illuminating the plant seedling with grow light during growth stages of the plant seedling growth process, and a controller for the controlling the spectral power distribution of the grow light emitted from the light source such that the grow light in at least some growth stages of the plant seedling growth process comprises more energy in the blue wavelength range than in other growth stages of the plant seedling growth process. In use cases where the grow light is supplementing available daylight, an additional sensor may be used to measure the amount and spectral composition of daylight and control the grow light such that spectral power distribution of total light received by the plant seedling is controlled accordingly.

US 2015/0128489 discloses a plant growing system wherein a first light source irradiates a plant with light having a peak wavelength in a range from 380 to 560 nm and a peak wavelength in a range from 560 to 680 nm and a second light source irradiates the plant with far-red light having a peak wavelength in a range from 685 to 780 nm. Further, a control unit controls the first and the second light source to perform respective irradiation operations and a time setting unit sets a first and a second time zone in which the control unit controls the first and the second light source to perform the respective irradiation operations. The first time zone ranges from a first predetermined time before sunset to a second predetermined time after sunset, and the second time zone starts after the first light source completes its irradiation operation.

US 2018/0116127 relates to systems and methods of illuminating plants to providing supplemental lighting in addition to natural light to plants and improving the crop yield when using such supplemental lighting. The invention is suited for use in horticulture in greenhouses.

### SUMMARY OF THE INVENTION

To that end, a computer-implemented method is disclosed for controlling one or more luminaires that are configured to illuminate one or more plants with artificial light. Artificial light comprises a plurality of artificial light components. Each of the artificial light components is of a respective wavelength or wavelength range. The plurality of artificial light components comprises a first artificial light component of a first wavelength or wavelength range and a second artificial light component of a second wavelength or wavelength range. Further, sunlight is incident on the one or more plants. Sunlight comprises a plurality of sunlight components. Each of the sunlight components is of a respective wavelength or wavelength range. The plurality of sunlight components comprising a first sunlight component of the first wavelength or wavelength range and a second sunlight component of the second wavelength or wavelength range. The method comprises receiving a signal indicative of a non-spectrally resolved irradiance value of sunlight that is incident on the one or more plants.

The method further comprises determining, based on the non-spectrally resolved irradiance value, a first irradiance value for the first artificial light component and a second irradiance value for the second artificial light component. The method further comprises controlling the one or more luminaires such that they provide artificial light to the one or more plants having the determined first irradiance value for the first artificial light component and the determined second irradiance value for the second artificial light component, such that the one or more plants receive light of the first wavelength or wavelength range at a first predefined irradiance value and light of the second wavelength or wavelength range at a second predefined irradiance value.

Advantageously, the method allows to provide—in an energy efficient manner—the one or more plants with sufficient PAR even when the irradiance values of different light components in the sunlight change with respect to each other or, loosely speaking, when the shape of the EM spectrum of the sunlight changes. It is known that the EM spectrum of sunlight changes during the day. The EM spectrum of sunlight during the day for example comprises relatively strong blue and green components relative to the red light component in the sunlight, whereas during sunset, the EM spectrum of sunlight shows relatively weak blue and green light components relative to the red light component in the sunlight. By being able to adapt the different light components of the artificial light separately it is possible to specifically adapt each artificial light component in the artificial light as required in response to the change of its corresponding light component in the sunlight. If, hypothetically speaking, only the irradiance values of the blue and green light components of sunlight would decrease during dusk, then it would be only necessary to increase the blue and green artificial light components in the artificial light, and not the red light component, to keep acceptable PAR spectral power distribution. Any increase of the artificial red light component, which would for example be performed if only the total irradiance value of the artificial light could be controlled, may cause too high irradiance levels of red light on the one or more plants. In such case, part of the generated red artificial light component may not be used for photosynthesis and may thus be lost. The method thus allows to maintain the light use efficiency, LUE, typically expressed in g/mol at high levels. Light use efficiency, LUE, defines the vegetation efficiency of converting radiative energy into biochemical energy through photosynthesis. The LUE describes how efficiently plants use the incident light for growth. The LUE can be calculated by dividing the dry weight of a plant by the total incident light that the plant received throughout the growing period.

The method is further advantageous in that the method enables that the plants receive an appropriate irradiance value for the first and second wavelength (range) without requiring measuring the spectrum of sunlight that is incident on the one or more plants and/or without requiring spectrally resolved input control signals, i.e., control signals that indicate for separate wavelengths or wavelength ranges a separate irradiance value. Hence, this method enables to use relatively simple irradiance sensors, e.g. sensors that can only measure a total irradiance value for some fixed wavelength range, e.g., the PAR wavelength range or the visible light wavelength range, and/or relatively simple control infrastructures, e.g., only requiring a irradiance value for the overall artificial light to be incident on the one or more plants as control input, while at the same time ensuring that the plants receive appropriate irradiance levels for different wavelengths or wavelength ranges.

The signal may indicate a (non-spectrally resolved) total irradiance value of incident sunlight in that it indicates an irradiance value of a relatively broad wavelength range, broader than the first and second wavelength range. This would typically depend on the sensor used for measuring the total irradiance of the sunlight. The total irradiance value may be representative for the irradiance over a substantial part of the photosynthetic active radiation (PAR) wavelength range of 400 nm to 700 nm. Alternatively, the total irradiance value may be representative of the irradiance over a substantial part of the visible wavelength range of about 380 nm to about 750 nm. Further, the total irradiance value may be representative of the irradiance over a part of full-spectrum sunlight radiation going from near-ultraviolet to near-infrared, i.e., from about 300 nm to about 1400 nm, and considered useful for plant and animal life. This relatively broad wavelength range may or may not comprise the first wavelength or wavelength range and may or may not comprise the second wavelength range. This relatively broad wavelength range may comprise wavelengths that are not in the first wavelength range and not in the second wavelength range.

Preferably, the signal indicates the total irradiance value of sunlight as incident on the one or more plants just prior to a first time or a second time. In an embodiment, a signal indicating a current total irradiance value of sunlight is repeatedly received, e.g. every second or every minute, such that irradiance values of the first artificial light component and second artificial light component can be repeatedly determined for any time, also for the first time and for the second time.

Of course, based on the indicated total irradiance value of sunlight many more irradiance values may be determined for respective many more wavelengths or wavelength ranges.

The light that the one or more plants receive is the combination of sunlight and artificial light. Thus, light of the first wavelength or wavelength range being provided at the first predefined irradiance value may be understood as that the first irradiance value of the first artificial light component plus the irradiance value of the first sunlight component equals the first predefined irradiance value.

Preferably, the non-spectrally resolved irradiance value is one total irradiance value for one or more wavelength ranges. Preferably, the signal is indicative of one and only one irradiance value.

Preferably, the signal does not comprise spectrally resolved data, thus does not indicate different irradiance values for different light components of the light concerned, i.e. the light to which the signal relates. Spectrally resolved data may be understood as data indicating at least a first irradiance value for a first wavelength or wavelength range and a second irradiance value for a second wavelength or wavelength range.

Determining the first irradiance value for the first artificial light component and the second irradiance value for the second artificial light component may be performed by determining an appropriate electromagnetic (EM) spectrum for the artificial light. Determining an EM spectrum may be understood as involving, per definition, determining separate irradiance values for separate light components.

The first and second predefined irradiance values may be the same or different. A light recipe may be defined for the one or more plants which defines, for each of a plurality of times, an EM spectrum that the one or more plants should receive. Such light recipe may be determined based on various factors, such as based on the species of the plants and/or on the age/life phase of the plant and/or based on the time of year, e.g. season, in which the plants are illuminated, time of day, and/or based on an amount of light (number of photons) received during a previous time period, e.g. the last two days, and/or based on an amount of light (number of photons) that the one or more plants are predicted to receive in e.g. the coming two days. Of course, the desired EM spectrum may be the same for a first time and a second time as referred to above.

Controlling the one or more luminaires may comprise separately adjusting respective irradiances of different artificial light components. This may be performed by sending respective control signals to each of a plurality of illumination devices, wherein each illumination device is configured to generate a respective artificial light component. To illustrate, a first illumination device may be a green light LED, a second illumination device may be a blue light LED and a third illumination device may be a red light LED. By sending different control signals to these different LEDs, the composition, the EM spectrum, of the artificial light can be suitably controlled, at least with regards to the blue, green and red artificial light components in the artificial light. Each light component may be said to be associated with a color channel of an illumination system. Using this terminology, separately adjusting irradiances of respective light components may be performed by separately controlling respective color channels of the illumination system. A luminaire may comprise one type of illumination device configured to generate one artificial light component or a luminaire may comprise a plurality of different types of illumination devices each configured to the generate a different artificial light component.

It should be appreciated that a light component as used herein may refer to a wavelength range. This may be understood as that the light component only comprises light of wavelengths within that range and no light having wavelengths outside of that range. The light components of the artificial light may be understood to have non-overlapping wavelengths and/or non-overlapping wavelengths ranges. Alternatively, the light components of the artificial light may have overlapping wavelength ranges. In any case, if a light component is of a wavelength range, adjusting the irradiance of that light component does not necessarily imply that the irradiances of all wavelengths within that wavelength range are adjusted by the same factor.

As used herein, “irradiance” is flux density expressed in Watt per square meter at the plant level (e.g., leaves) which can be expressed in μmol/s/m². Typically, adjusting an irradiance of an artificial light component as incident on the one or more plants is performed by adjusting the “radiant flux” of the artificial light component as generated by an illumination device. Radiant flux can be expressed as Watt. For a particular setup of one or more plants and an illumination device, the irradiance of an artificial light component as incident on the one or more plants is linked to the radiant flux of that artificial light component as generated by the illumination device. This relation between radiant flux and irradiance can be determined in a straightforward manner, for example by simply setting the radiant flux from an illumination device for an artificial light component at respective radiant flux values, and measuring, for each of the values, the irradiance value at the one or more plants. In light of the above, determining an irradiance value may also refer to determining the corresponding radiant flux value that the illumination device should generate. Likewise, adjusting an irradiance as incident on the one or more plants of some light component may also refer to adjusting the radiant flux of that light component as generated by the illumination device.

In present disclosure and unless otherwise indicated, the following definitions will be used:
a “first irradiance value” refers to an irradiance value for a first artificial light component of a first wavelength or wavelength range, at a first time;
a “second irradiance value” refers to an irradiance value for a second artificial light component of a second wavelength or wavelength range, at the first time;
a “third irradiance value” refers to an irradiance value for the first artificial light component of the first wavelength or wavelength range at a second time;
a “fourth irradiance value” refers to an irradiance value for the second artificial light component of the second wavelength or wavelength range at the second time;
a “fifth irradiance value” refers to an irradiance value for a first sunlight component of the first wavelength or wavelength range, at the first time;
a “sixth irradiance value” refers to an irradiance value for a second sunlight component of the second wavelength or wavelength range, at the first time;
a “seventh irradiance value” refers to an irradiance value for the first sunlight component of the first wavelength or wavelength range, at the second time;
an “eighth irradiance value” refers to an irradiance value for the second sunlight component of the second wavelength or wavelength range, at the second time;
a “first predetermined irradiance value” refers to a predetermined irradiance value for the first wavelength or wavelength range, at the first time;
a “second predetermined irradiance value” refers to a predetermined irradiance value for the second wavelength or wavelength range, at the first time;
a “third predetermined irradiance value” refers to a predetermined irradiance value for the first wavelength or wavelength range, at the second time;
a “fourth predetermined irradiance value” refers to a predetermined irradiance value for the second wavelength or wavelength range, at the second time.

In an embodiment, the non-spectrally resolved irradiance value is an irradiance value of sunlight that is incident on the one or more plants. In such embodiment, determining the first and second irradiance value may comprise:
determining, based on the non-spectrally resolved irradiance value, a fifth irradiance value of a first sunlight component incident on the one or more plants, the first sunlight component having the first wavelength or wavelength range and a sixth irradiance value of a second sunlight component incident on the one or more plants, the second sunlight component having the second wavelength or wavelength range, and
based on the first predefined irradiance value for the first wavelength or wavelength range and based on the fifth irradiance value of the first sunlight component, determining the first irradiance value for the first artificial light component, and
based on the second predefined irradiance value for the second wavelength or wavelength range and based on the determined sixth irradiance value of the second sunlight component, determining the second irradiance value for the second artificial light component.

In this embodiment, a relatively simple light sensor may be used that can only measure a non-spectrally resolved sunlight irradiance value. This single irradiance value is sufficient for determining the irradiance values of respectively the first and second sunlight component, as described further below. In an example, a complete EM spectrum of the sunlight incident on the one or more plants may be determined based on a single non-spectrally resolved irradiance value.

In a preferred embodiment, the first irradiance value is a difference between the first predefined irradiance value and the fifth irradiance value, and likewise, the second irradiance value is a difference between the second predefined irradiance value and the sixth irradiance value. Thus, determining the first, resp. second, irradiance value for the first, resp. second, artificial light component may comprise determining a difference between the first, resp. second, predefined irradiance value and the first, resp. second, irradiance value for the first, resp. second, sunlight component. Thus, in an example the method may comprise determining that the first sunlight component is not sufficiently strong for providing the one or more plants with the first predefined irradiance value, as a result of which the irradiance value of the first artificial light component may be increased.

In an embodiment, the method comprises storing sunlight reference data indicating, for each of a plurality of reference non-spectrally resolved irradiance values, a reference irradiance value for the first sunlight component and a reference irradiance values for the second sunlight component. Herein, determining the irradiance value of the first sunlight component and the irradiance value of the second sunlight component is performed based on the sunlight reference data.

The sunlight reference data may indicate, for each reference non-spectrally resolved irradiance value, a time of day and/or a time of year, preferably a date. Then, the irradiance value of the first sunlight component and second sunlight component may be determined based on a current time of day and/or a current time of year and based on the reference data.

In an example, for each prestored non-spectrally resolved, e.g., total, irradiance value of sunlight, a complete EM spectrum of the sunlight is stored. Based on this EM spectrum and based on the predefined irradiance values, the appropriate irradiance values for respective artificial light components can be determined, for example by determining the difference between the EM spectrum of the sunlight and a predefined EM spectrum that should be incident on the one or more plants.

The non-spectrally resolved irradiance values of sunlight may be stored in association with respective sets of irradiance values for sunlight components of the sunlight, in that a first relation is stored between total irradiance of the sunlight and irradiance of the first sunlight component and a second relation is stored between total irradiance of the sunlight and irradiance of the second sunlight component. Based on these relations and given a non-spectrally resolved irradiance value of sunlight, the irradiance value of the first sunlight component and the irradiance value of the second sunlight component can be calculated.

The sunlight reference data may comprise estimated, calibrated or measured values for the various sunlight components associated with a reference non-spectrally resolved sunlight irradiance value.

In an embodiment, the sunlight that is incident on the one or more plants has a first electromagnetic, EM, spectrum at a first time and a second EM spectrum at a second time after the first time. The second EM spectrum is different from the first EM spectrum. In this embodiment, the received signal is indicative of the non-spectrally resolved irradiance value of the sunlight that is incident on the one or more plants at the first time. Further, this embodiment comprises receiving a second signal indicative of the non-spectrally resolved irradiance value of the sunlight that is incident on the one or more plants at the second time. This embodiment also comprises determining, based on the second non-spectrally resolved irradiance value, a seventh irradiance value of the first sunlight component incident on the one or more plants, and a eighth irradiance value of the second sunlight component incident on the one or more plants. This embodiment also comprises, based on a third predefined irradiance value for the first wavelength or wavelength range and based on the determined seventh irradiance value of the first sunlight component, determining a third irradiance value for the first artificial light component, and, based on a fourth predefined irradiance value for the second wavelength or wavelength range and based on the determined eighth irradiance value of the second sunlight component, determining a fourth irradiance value for the second artificial light component. Then, the one or more luminaires may be controlled such that they provide artificial light to the one or more plants having the determined third irradiance value for the first artificial light component and the determined fourth irradiance value for the second artificial light component, such that the one or more plants receive, at the second time, light of the first wavelength or wavelength range at the third predefined irradiance value and light of the second wavelength or wavelength range at the fourth predefined irradiance value.

This embodiment allows spectrally selective adjustment of the artificial light so that, at any given time and fluctuation in the sunlight non-spectrally resolved irradiance and/or sunlight EM spectrum, the one or more plants receive appropriate horticulture light.

The first and second predefined irradiance values may be specifically defined for the first time. The third and fourth predefined values may be specifically defined for the second time.

The third predefined value may be equal to the first predefined value. Likewise, the fourth predefined value may be equal tot the second predefined value. This would for example be the case if the light recipe does not change between the first and second time.

It should be appreciated that, for any given time, many more predefined irradiance values may be respectively defined for many more wavelengths or ranges. For example, it may be that for any given time, a complete EM spectrum is defined that the one or more plants should receive.

Preferably, the first irradiance value and fifth irradiance value, both determined for the first time, together add up to the first predefined irradiance value. Likewise, preferably, the second irradiance value and sixth irradiance value together add up to the second predefined irradiance value. Likewise, preferably, the third irradiance value and seventh irradiance value together add up to the third predefined irradiance value. Likewise, preferably, the fourth irradiance value and eighth irradiance value together add up to the fourth predefined irradiance value.

In an embodiment, a ratio between the first irradiance value and the second irradiance value, Eₑ₁/Eₑ₂, differs from a ratio between the third irradiance value and fourth irradiance value, Eₑ₃/Eₑ₄. Additionally, or alternatively, a ratio between the first irradiance value and third irradiance value, Eₑ₁/Eₑ₃, differs from a ratio between the second irradiance value and fourth irradiance value, Eₑ₂/Eₑ₄.

In this embodiment, the irradiance values of the first and second artificial light components are adjusted with respect to each other, which enables to provide, at any given time, the appropriate irradiance value for each artificial light component such that no artificial light is wasted in the sense that the one or more plants receive higher irradiance values than defined/required.

In an embodiment, the first wavelength range is between 400-500 nm (blue) and the second wavelength range is between 600-700 nm (red). In another embodiment, the first wavelength range is between 600-700 nm (red) and the second wavelength range is between 700-800 nm (far-red). In such embodiment, for non-spectrally resolved sunlight irradiance values, a total irradiance of the sunlight incident on the one or more plants at the second time may be lower respectively higher than a total irradiance of the sunlight incident on the one or more plants at the first time. In such case, preferably, the ratio between the first irradiance value and third irradiance value, Eₑ₁/Eₑ₃, is smaller respectively larger than the ratio between the second irradiance value and fourth irradiance value, Eₑ₂/Eₑ₄.

Preferably, if the fifth irradiance value, Eₑ₅, is lower than the first predefined irradiance value, the first irradiance value, Eₑ₁, is nonzero and is selected such that the one or more plants receive in total, at the first time, light of the first wavelength or wavelength range at the first predefined irradiance value. Preferably, if the fifth irradiance value, Eₑ₅, is equal to or higher than the first predefined irradiance value, the first irradiance value, Eₑ₁, is substantially zero.

Preferably, if the sixth irradiance value, Eₑ₆, is lower than the second predefined irradiance value, the second irradiance value, Eₑ₂, is nonzero and is selected such that the one or more plants receive in total, at the first time, light having the second wavelength or wavelength range at the second predefined irradiance value. Preferably, if the sixth irradiance value, Eₑ₆, is equal to or higher than the second predefined irradiance value, the second irradiance value, Eₑ₂, is substantially zero.

Preferably, if the seventh irradiance value, Eₑ₇, is lower than the third predefined irradiance value, the third irradiance value, Eₑ₃, is nonzero and is selected such that the one or more plants receive in total, at the second time, light having the first wavelength or wavelength range at the third predefined irradiance value. Preferably, if the seventh irradiance value, Eₑ₇, is equal to or higher than the third predefined irradiance value, the third irradiance value, Eₑ₃, is substantially zero.

Preferably, if the eighth irradiance value, Eₑ₈, is lower than the fourth predefined irradiance value, the fourth irradiance, Eₑ₄, value is nonzero and is selected such that the one or more plants receive in total, at the second time, light having the second wavelength or wavelength range at the fourth predefined irradiance value. Preferably, if the eighth irradiance value, Eₑ₈, is equal to or higher than the fourth predefined irradiance value, the fourth irradiance value, Eₑ₄, is substantially zero.

These embodiments ensure that no artificial light is wasted.

In an embodiment, determining the first irradiance value, Eₑ₁, comprises determining a difference between the fifth irradiance value, Eₑ₅, and the first predefined irradiance value; and/or
determining the second irradiance value, Eₑ₂, comprises determining a difference between the sixth irradiance value, Eₑ₆, and the second predefined irradiance value; and/or
determining the third irradiance value, Eₑ₃, comprises determining a difference between the seventh irradiance value, Eₑ₇, and the third predefined irradiance value; and/or
determining the fourth irradiance value, Eₑ₄, comprises determining a difference between the eighth irradiance value, Eₑ₈, and the fourth predefined irradiance value.

In an embodiment, the method comprises determining, e.g. measuring, for the first wavelength or wavelength range a first total irradiance value, Eₜₒₜₐₗ₁, as received by the one or more plants at a first time and controlling, based on the first total irradiance value, Eₜₒₜₐₗ₁, and based on the first predefined irradiance value, the irradiance of the first artificial light component to be incident on the one or more plants at the first irradiance value, Eₑ₁, at the first time; and/or
determining, e.g. measuring, for the second wavelength or wavelength range a second total irradiance value, Eₜₒₜₐₗ₂, as received by the one or more plants at a first time and controlling, based on the second total irradiance value, Eₜₒₜₐₗ₂, and based on the second predefined irradiance value, the irradiance of the second artificial light component to be incident on the one or more plants at the second irradiance value, Eₑ₂, at the first time; and/or
determining, e.g. measuring, for the first wavelength or wavelength range a third total irradiance value, Eₜₒₜₐₗ₃, as received by the one or more plants at a second time and controlling, based on the third total irradiance value, Eₜₒₜₐₗ₃, and based on the third predefined irradiance value, the irradiance of the first artificial light component to be incident on the one or more plants at the third irradiance value, Eₑ₄, at the second time; and/or
determining, e.g. measuring, for the second wavelength or wavelength range a fourth total irradiance value, Eₜₒₜₐₗ₄, as received by the one or more plants at a second time and controlling, based on the fourth total irradiance value, Eₜₒₜₐₗ₄, and based on the fourth predefined irradiance value, the irradiance of the second artificial light component to be incident on the one or more plants at the fourth irradiance value, Eₑ₄, at the second time.

Measuring a total irradiance value as received by the one or more plants at some time may be performed by positioning an irradiance sensor at the plants such that the sensor receives both the artificial light and the sunlight. Preferably, these total irradiance values are measured just before the first time and just before the second time. These measurements may be performed repeatedly, e.g., every second, such that the artificial light can be appropriately adjusted at any time, e.g. adjusted such that the artificial light has the appropriate EM spectrum at the first and/or second time.

In this embodiment, the method may comprise determining a difference between a total irradiance value as received by the one or more plants, such as Eₜₒₜₐₗ₁, Eₜₒₜₐₗ₂, Eₜₒₜₐₗ₃, Eₜₒₜₐₗ₄, and a predefined irradiance value, such as resp. the first, second, third, fourth predefined irradiance value. Based on this difference the EM spectrum of the artificial light can appropriately be adjusted

One aspect of this disclosure relates to an illumination system for illuminating one or more plants with artificial light, the illumination system comprising:
an illumination device that is configured to generate artificial light having a plurality of artificial light components, each of the artificial light components being of a respective wavelength or wavelength range, and configured to separately adjust irradiances of the respective light components, and
a control system comprising a processor that is configured to perform the method according to any of the preceding claims using the illumination device.

The illumination device may comprise a plurality of illumination sources adapted to generate artificial light having a plurality of artificial light components. The plurality of illumination sources do not need to correspond one-to-one with the plurality of artificial light components. For example, an illumination device comprises a blue illumination source, a red illumination source, and a white illumination source may provide artificial light in the red wavelength range by using only the red and white illumination source.

One aspect of this disclosure relates to a control system comprising an input interface for receiving a signal indicative of a non-spectrally resolved irradiance value; an output interface for sending an irradiance value for a first artificial light component and an irradiance value for a second artificial light component to an illumination device; and a processor wherein the processor that is configured to perform any of the methods described herein.

One aspect of this disclosure relates to a computer program comprising instructions to cause any of the illumination systems described herein to perform any of the methods described herein.

One aspect of this disclosure relates to a computer-readable medium having stored thereon any of the computer programs described herein.

One aspect of this disclosure relates to a controller comprising a processor that is configured to perform any of the methods described herein.

One aspect of this disclosure relates to a computer comprising a computer readable storage medium having computer readable program code embodied therewith, and a processor, preferably a microprocessor, coupled to the computer readable storage medium, wherein responsive to executing the computer readable program code, the processor is configured to perform any of the methods described herein.

One aspect of this disclosure relates to a computer program or suite of computer programs comprising at least one software code portion or a computer program product storing at least one software code portion, the software code portion, when run on a computer system, being configured for executing any of the methods described herein.

One aspect of this disclosure relates to a non-transitory computer-readable storage medium storing at least one software code portion, the software code portion, when executed or processed by a computer, is configured to perform any of the methods described herein.

As will be appreciated by one skilled in the art, aspects of the present invention may be embodied as a system, a method or a computer program product. Accordingly, aspects of the present invention may take the form of an entirely hardware embodiment, an entirely software embodiment (including firmware, resident software, microcode, etc.) or an embodiment combining software and hardware aspects that may all generally be referred to herein as a “circuit,” “module” or “system.” Functions described in this disclosure may be implemented as an algorithm executed by a processor/microprocessor of a computer. Furthermore, aspects of the present invention may take the form of a computer program product embodied in one or more computer readable medium(s) having computer readable program code embodied, e.g., stored, thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples of a computer readable storage medium may include, but are not limited to, the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of the present invention, a computer readable storage medium may be any tangible medium that can contain, or store, a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber, cable, RF, etc., or any suitable combination of the foregoing. Computer program code for carrying out operations for aspects of the present invention may be written in any combination of one or more programming languages, including an object oriented programming language such as Java (TM), Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems), and computer program products according to embodiments of the present invention. It will be understood that each block of the flowchart illustrations and/or block diagrams, and combinations of blocks in the flowchart illustrations and/or block diagrams, can be implemented by computer program instructions. These computer program instructions may be provided to a processor, in particular a microprocessor or a central processing unit (CPU), of a general purpose computer, special purpose computer, or other programmable data processing apparatus to produce a machine, such that the instructions, which execute via the processor of the computer, other programmable data processing apparatus, or other devices create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

Moreover, a computer program for carrying out the methods described herein, as well as a non-transitory computer readable storage-medium storing the computer program are provided. A computer program may, for example, be downloaded (updated) to the existing systems or be stored upon manufacturing of these systems.

Elements and aspects discussed for or in relation with a particular embodiment may be suitably combined with elements and aspects of other embodiments, unless explicitly stated otherwise. Embodiments of the present invention will be further illustrated with reference to the attached drawings, which schematically will show embodiments according to the invention. It will be understood that the present invention is not in any way restricted to these specific embodiments.

### BRIEF DESCRIPTION OF THE DRAWINGS

Aspects of the invention will be explained in greater detail by reference to exemplary embodiments shown in the drawings, in which:

FIGS. 1 illustrates a system according to an embodiment for illuminating one or more plants with artificial light;

FIG. 2 shows sunlight and artificial light spectra at two different times according to an embodiment;

FIG. 3 shows sunlight and artificial light spectra at two different times according to an embodiment;

FIG. 4 shows sunlight and artificial light spectra that may occur in an embodiment implementing a feedback loop;

FIG. 5A indicates efficacy per channel according to an embodiment;

FIG. 5B indicates the composition of white light and daylight;

FIG. 6 indicates a total irradiance value of artificial light during a day according to an embodiment;

FIG. 7 is a flow chart illustrating a method according to an embodiment;

FIG. 8 illustrates sunlight reference data according to an embodiment;

FIG. 9 illustrates a control system according to an embodiment.

### DETAILED DESCRIPTION OF THE DRAWINGS

In the figures, identical reference numbers refer to identical or similar elements.

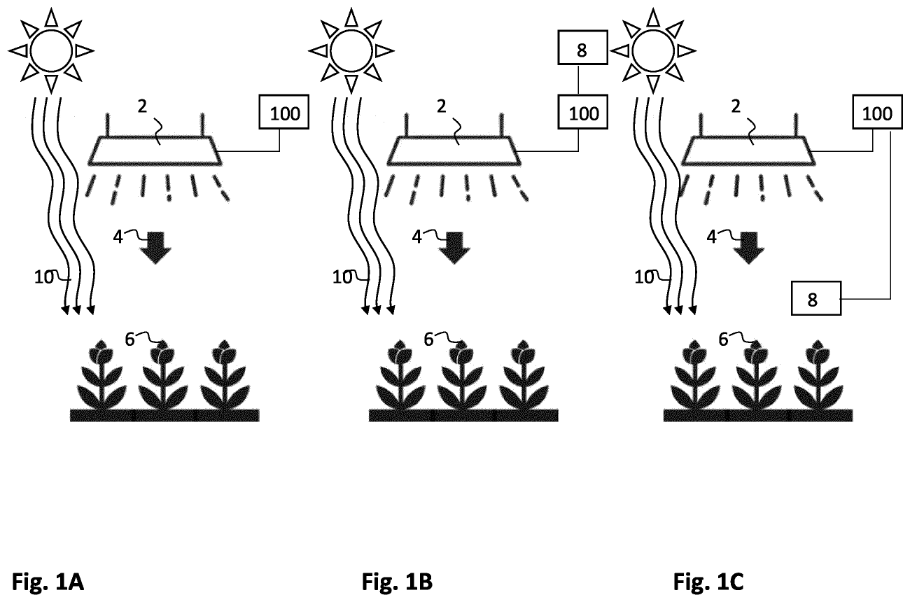

FIGS. 1 illustrates a system according to an embodiment for illuminating one or more plants with artificial light 4. The illumination system comprises an illumination device 2 that is configured to generate artificial light 4 having a plurality of artificial light components. Each of the artificial light components is of a respective wavelength or wavelength range. Further, the illumination device 2 can separately adjust irradiances of the respective light components. Typically, the illumination device comprises a plurality of separably controllable light sources, wherein at least some of the light sources emit different light colors. The system also comprises a control system 100, also referred to as a data processing system herein, comprising a processor that is configured to perform any of the methods described herein. The control system 100 is preferably configured to send control signals to the different light sources, e.g., LEDs, of illumination device 2 and to receive signals from sensors that may be present near the plants.

FIG. 1A illustrates that the one or more plants 6 may receive both artificial light 4 and sunlight 10. If the EM spectrum of the sunlight changes, for example because one sunlight component, e.g., red light, becomes relatively strong with respect to other light components, then it may be desired to only dim the corresponding artificial light component, e.g., the red light component of the artificial light. This ensures that, at any given time, the one or more plants receive an appropriate EM spectrum of light. Note that the notion of appropriate EM spectrum may depend on various factors. In any case, it should be appreciated that the desired EM spectrum can change over time.

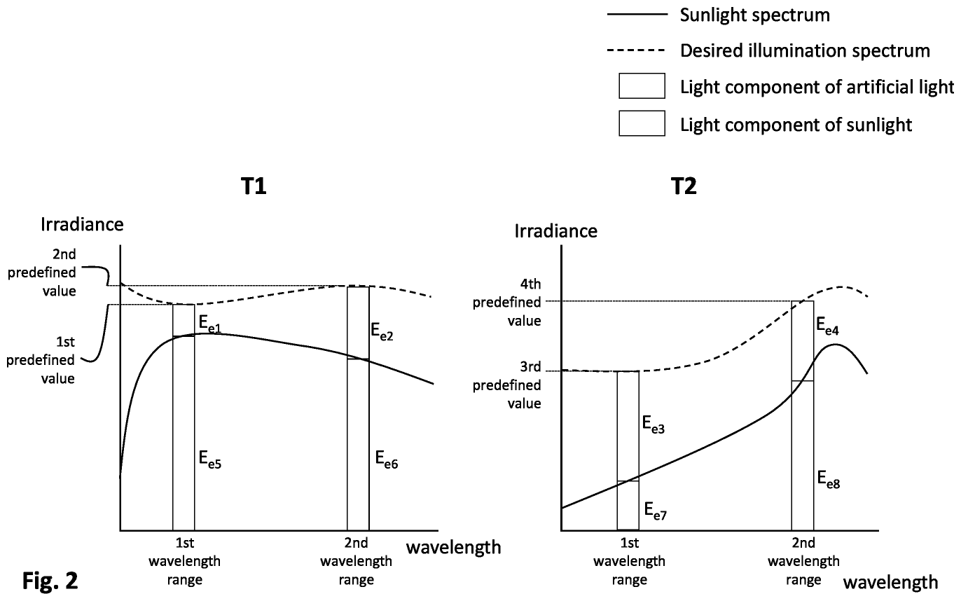

This is for example illustrated by FIG. 2. FIG. 2 shows two graphs for two respective times, termed T1 and T2. These times may be few hours apart, for example. In this case, T1 may refer to a time during the day and T2 a time during twilight. The vertical axes of the graphs represent irradiance and the horizontal axes wavelength. Each graph may be understood to depict a wavelength range from blue-green light on the left to red light on the right. In particular, the first wavelength range may be between 400-500 nm and the second wavelength range between 600-700 nm.

Each graph shows a so-called desired illumination spectrum for the one or more plants, as indicated by the dashed lines. FIG. 2 indicates that the desired illumination spectrum may change with time. Note that the desired illumination spectrum defines for T1 a first predefined value for the indicated first wavelength range and a second predefined value for the second wavelength range and for T2 a third predefined value for the indicated first wavelength range and a fourth predefined value for the second wavelength range. It should be appreciated that it is not required that a full desired EM spectrum is defined for the one or more plants. A predefined value may be defined for a selected number of wavelengths or wavelength ranges.

Further, each graph shows the EM spectrum of the sunlight that is incident on the one or more plants at the time in question. Note that at T1, during the day, the sunlight spectrum comprises relatively strong blue/green sunlight components, whereas at T2, during twilight, the sunlight spectrum comprises relatively weak blue/green sunlight components. In particular, at T1, the first sunlight component of the first wavelength range has an irradiance of Eₑ₅, also referred to as the “fifth irradiance value” herein, the second sunlight component of the second wavelength range has an irradiance of Eₑ₆, also referred to as the “sixth irradiance value” herein. At T2, the first sunlight component has an irradiance of Eₑ₇, also referred to as the “seventh irradiance value” herein, and the second sunlight component has an irradiance of Eₑ₈, also referred to as the “eighth irradiance value” herein.

At T1, in order for the one or more plants to receive an EM spectrum as desired, the artificial light comprises a first artificial light component of the first wavelength range at an irradiance of Eₑ₁, also referred to as the “first irradiance value” herein, and a second artificial light component of the second wavelength range at Eₑ₂, also referred to as the “second irradiance value” herein. As a result, the one or more plants receive at T1, in total, light of the first wavelength range having the first predefined irradiance value and light having the second wavelength range having the second predefined irradiance value. Similarly, at T2, the artificial light comprises light of the first wavelength range having an irradiance of Eₑ₃, also referred to as the “third irradiance value” herein, and light of the second wavelength range having an irradiance of Eₑ₄, also referred to as the “fourth irradiance value” herein. The irradiance values for the artificial light components can be determined based on a difference, for each light component, between the predefined irradiance value and the irradiance value already provided by the sunlight.

FIG. 2 shows that the ratio Eₑ₁/Eₑ₂, differs from the ratio Eₑ₃/Eₑ₄, and that the ratio Eₑ₁/Eₑ₃, differs from the ratio Eₑ₂/Eₑ₄. These differing ratio's indicate that the different artificial light components are separately controlled.

Further, assuming that the total irradiance of sunlight at T2 is lower than at T1, e.g. because T2 is at twilight and T1 during the day, we see that the ratio Eₑ₁/Eₑ₃ is smaller than the ration Eₑ₂/Eₑ₄. The irradiance of the first artificial light component is increased more profoundly than the irradiance of the second artificial light component.

It should be appreciated that FIG. 2 merely shows an example of a situation wherein it gets darker. However, the method and system can, of course, also be used when the situation gets brighter, e.g. when the sun is rising.

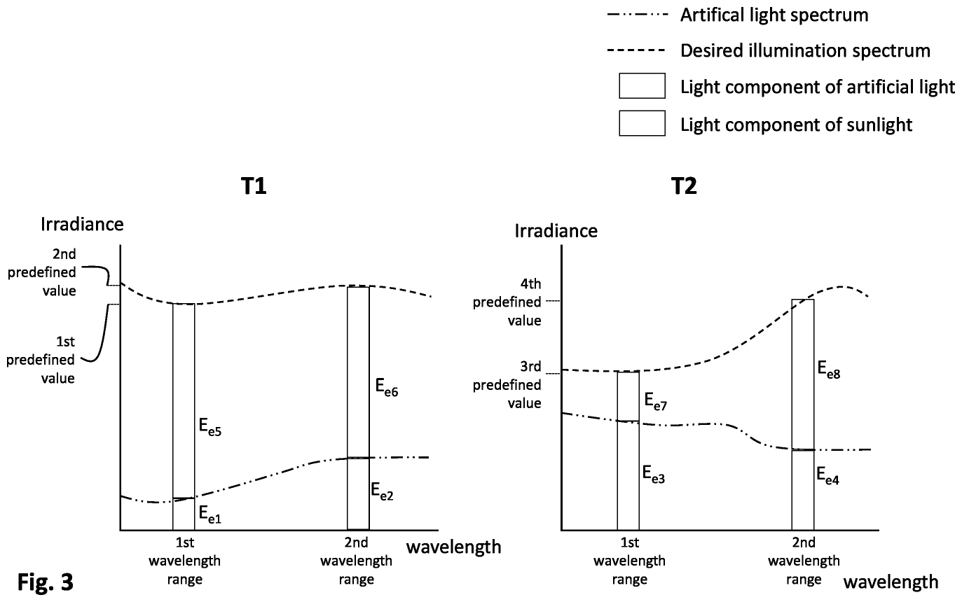

The graphs of FIG. 3 contain the same information as the graphs of FIG. 2, however, the graphs explicitly show the artificial light spectrum more explicitly (see the dash-dotted line).

As is clear from the above, the system preferably knows, at any given time, the EM spectrum of the sunlight that is incident on the one or more plants. This namely allows to accurately determine the irradiance values for respective artificial light components such that the one or more plants receive, in total, an EM spectrum as appropriate.

To this end, as depicted in FIG. 1B, the system may comprise a sensor 8 for measuring the EM spectrum, or at least two irradiance values for two respective wavelengths or wavelength ranges of the sunlight 10 that is incident on the one or more plants. Note that this sensor 8 is preferably positioned such that it does not receive artificial light 4 generated by illumination device 2. Based on the measured EM spectrum, and based on the desired EM spectrum can the appropriate spectrum for the artificial light be determined.

It should be appreciated that sensor 8 is not necessarily configured for measuring spectrally-resolved irradiance values, i.e. at least two separate irradiance values for at least two respective wavelengths or wavelength ranges. For example, the sensor 8 is configured to (merely) measure non-spectrally resolved irradiance value, e.g., a total irradiance of sunlight that is incident on the one or more plants. The sensor 8 may transmit a signal to the control system 100 indicating this total irradiance value. The controller 100 can then determine the appropriate irradiance values for the artificial light components based on this total irradiance value.

The control system 100 may for example have stored respective total irradiance values of sunlight in association with respective sets of irradiance values, each set comprising an irradiance value for a first sunlight component of the first wavelength or wavelength range and an irradiance value for a second sunlight component of the second wavelength or wavelength range. For example, the control system 100 may have sunlight reference data indicating, e.g., for respective total irradiance values of sunlight, respective EM spectra of the sunlight. Based on this, the control system can determine the current EM spectrum of the sunlight and subsequently, based on the determined EM spectrum of the sunlight, an appropriate spectrum for the artificial light such that the one or more plants receive a desired EM spectrum.

FIG. 1C illustrates yet another embodiment of the system. Herein, the sensor 8 is positioned such that it receives both sunlight 10 and artificial light as generated by the illumination device 2. In this embodiment, preferably, sensor 8 is configured to measure respective irradiance values for respective light components. Sensor 8 is preferably configured to measure the EM spectrum that the one or more plants receive. Note that both sunlight 10 and the artificial light 4 contribute to the EM spectrum received by the one or more plants.

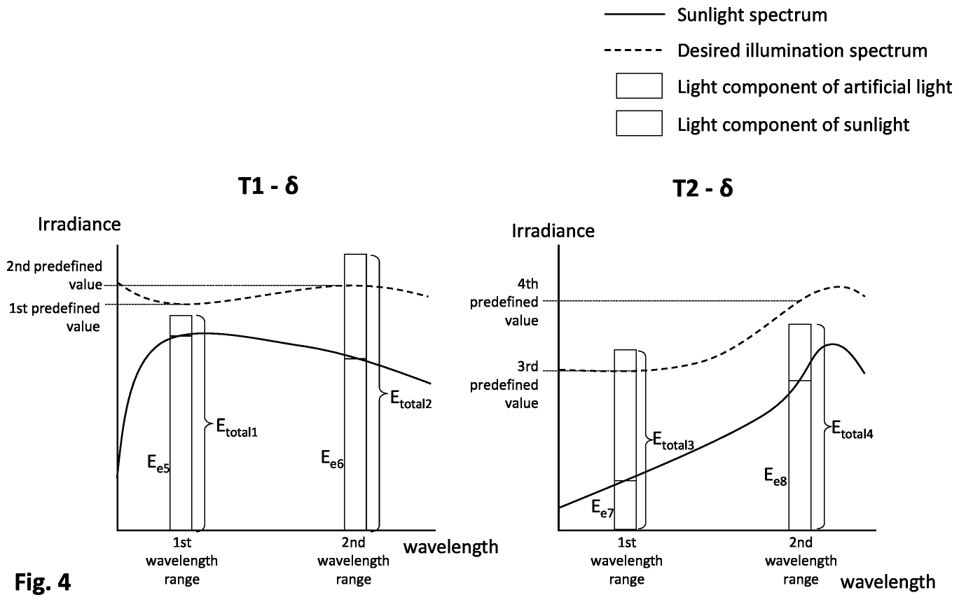

Such setup enables to implement a feedback loop as will be described with reference to FIG. 4. Sensor 8 may namely continuously measure the EM spectrum incident on the one or more plants and may feed this EM spectrum back to the control system 100. The control system 100 may then monitor, for each light component, whether it is at the predefined level or not. If, for a light component the irradiance value is below the predefined value, then the control system 100 may control the illumination system to increase the irradiance for that light component until the control system 100 receives again a signal from the sensor 8 indicating that the Irradiance value for that light component is at the predefined level. If, for a light component the irradiance value is above the predefined value, then the control system 100 may control the illumination system to decrease (dim) the irradiance for that light component until the control system 100 receives again a signal from the sensor 8 indicating that the irradiance value for that light component is at the predefined level.

FIG. 4 indicates the situation at two times T1-delta and T2-delta. Here, the delta may be relatively small, e.g., a few seconds, however, this depends on how responsive the system should be.

In any case, at T1-delta, sensor 8 has measured a total irradiance value for the first light component that is lower than the predefined value and a total irradiance value for the second light component that is higher than the predefined value. After the control system 100 has received a signal from sensor 8 indicating this, the control system 100 may determine the appropriate irradiance values for the light components by increasing the irradiance value of the first light component in the artificial light and by decreasing the irradiance value of the second light component in the artificial light component and monitoring (using again the feedback loop) when the irradiance values are at their respective predefined levels (as shown in FIG. 2).

At T2-delta, the irradiance value of the first light component is too high and of the second light component too low. The correct values can be determined similarly as described for the T1-delta case.

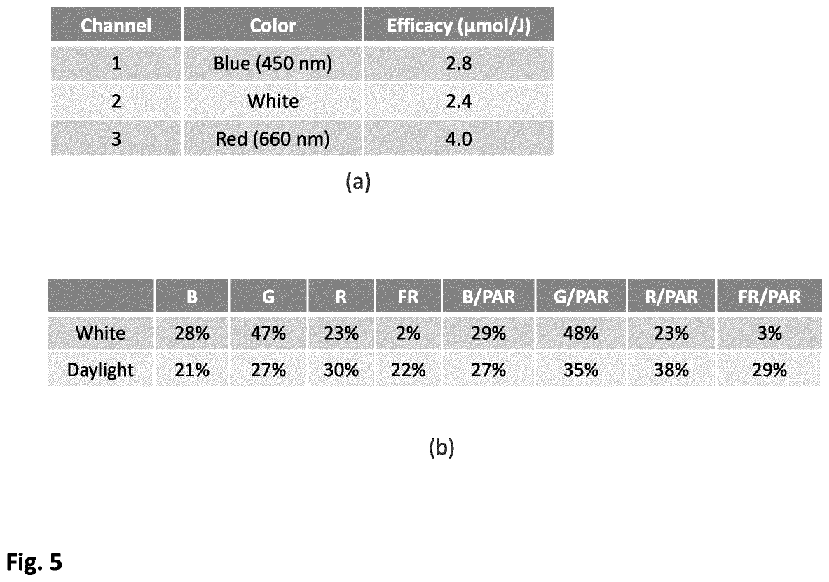

FIG. 5A is a table showing, for an embodiment of the illumination system, the separately controllable channels (channels 1, 2 and 3). Such system could be based on a single illumination device, having 3 different channels, or based on 3 different illumination devices with each illumination device considered to be a separate channel, or a combination. An illumination device may be a luminaire.

In this embodiment, channel 1 produces blue light, channel 2 produces white light, and channel 3 produces red light. White light typically consists of a combination of B, G, R, and a small fraction of FR (Far Red light). Far Red light may be understood as light having a wavelength between 700-800 nm.

Typically, the energy efficiency (or rather efficacy) of these channels will be different. In general, to produce 1 mole of photons, the red channel (channel 3) will require the least energy and the red channel will thus typically be the channel with the highest efficacy. A white channel typically has a lower efficacy.

FIG. 5B shows, for reference, the composition of daylight and white light. Here, PAR is the so-called photosynthetically active radiation and is the sum of all radiation in the B, G, and R wavelength bands (expressed in μmol/s/m2).

The following general principles relating to supplemental lighting may be implemented:
In the case of supplemental lighting for greenhouse horticulture, the supplemental light is preferably provided at times when the daylight level is low. The process of photosynthesis namely shows a linear relation with light level for low light levels. Increasing the light level will at some point result in saturation of photosynthesis. When saturation occurs, the light use efficiency (LUE) goes down, which is undesired. Therefore, a good supplemental light level is related to the daylight level: The lower the daylight level, the higher the supplemental light level can be, and vice versa.
There is an optimal integral amount of light for any crop (the so-called daily light integral (DLI)), being a compromise between biomass or fruit production versus LUE (for tomato, the desired DLI typically is 15 mol/m2/day).
Most crops need a period of darkness. For tomatoes, this period of darkness should be at least 6 hours. Crop deficiencies will occur if this rule is not obeyed.
Plants require a certain minimum fraction of blue light in the spectrum of light offered, to ensure opening of the stomata for CO2 uptake, among others.
The LUE is the highest for red light, followed by blue and white (or green).

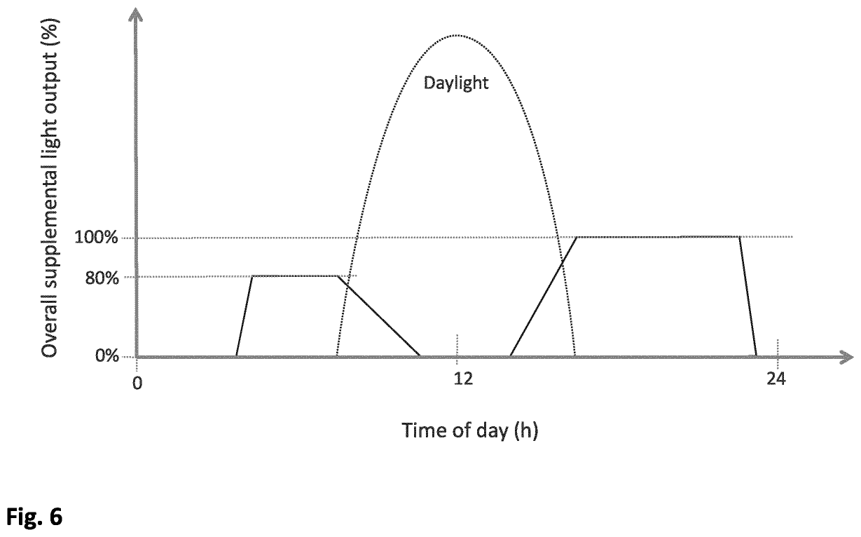

Keeping these principles in mind, a supplemental light profile over the day might look like depicted in FIG. 6 (solid line). It is assumed that the grower expects that a dimming level of 80% suffices to reach a desired DLI. In this example, the supplemental light is switched on at 05:00 h, at a dimming level of 80%. When the daylight level increases, the supplemental light level is gradually dimmed down. At the end of the daylight period, it might have become clear that a dimming level of 80% is insufficient to reach the desired DLI, so the supplemental light level is gradually increased to 100% at the end of the daylight period. The supplemental lighting is switched off at 23:00 to ensure the plants receive a period of darkness of sufficient duration.

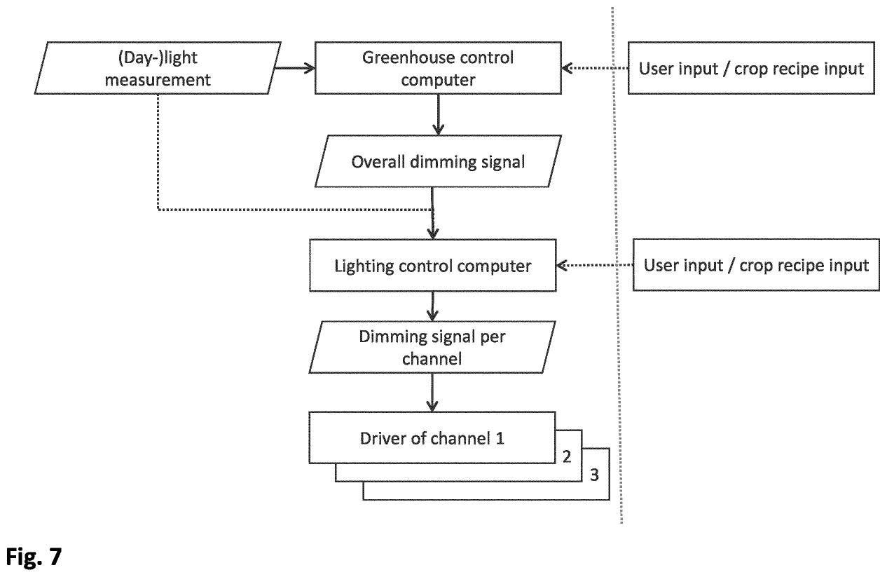

A flow chart of the aforementioned steps is shown in FIG. 7. The greenhouse control computer, e.g., controller 100a, may receive daylight measurements and/or user input. The daylight measurements may be spectrally resolved. The user input may indicate a desired EM spectrum for the one or more plants, i.e., the total EM spectrum (combination of sunlight and artificial light) that the one or more plants should receive. Based on the daylight measurement and user input, the greenhouse control computer may output an overall dimming signal. Such overall dimming signal may be regarded as a non-spectrally resolved dimming signal in that it does not indicate at least two dimming levels for at least two respective channels.

The lighting control system may then determine, based on the overall dimming signal, a dimming signal per channel thus determining for at least two artificial light components an appropriate irradiance value. These dimming signals for the different channels may then be sent to the different drivers of the illumination sources so that the plants receive appropriate lighting.

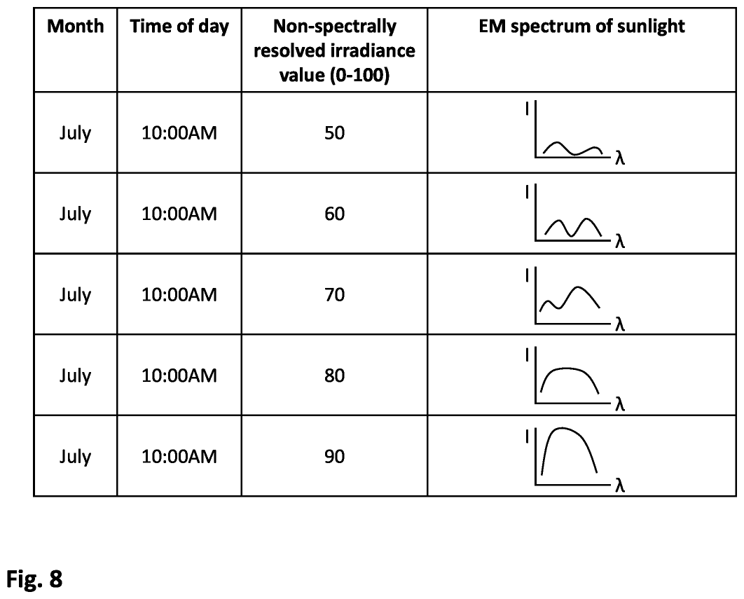

FIG. 8 shows part of sunlight reference data according to an embodiment. Each row contains a reference non-spectrally resolved irradiance value, in this example ranging from 50/100 to 90/100. Further, each non-spectrally resolved irradiance value is associated (see the rightmost column) with a reference EM spectrum of sunlight (which thus indicates a reference irradiance value for a first sunlight component and a reference irradiance values for a second sunlight component).

The reference non-spectrally resolved irradiance values and associated reference sunlight EM spectrum may have been measured, for example.

Further, in this example, each reference irradiance value is also associated with a month and a time of day. In this example, each reference value is associated with the same month and same day, namely “July” and 10:00 AM. Of course, in practice, the sunlight reference data may contain more entries, for all months, and many more times of day, for many more reference irradiance values.

If a controller as described herein receives a non-spectrally resolved irradiance value of sunlight in July, around 10:00 AM, then the controller can determine which EM spectrum the sunlight has based on these sunlight reference data, e.g., by simply selecting the reference EM spectrum of the reference irradiance value that is closest to the received (measured) irradiance value, as the actual EM spectrum of the sunlight. This in turn allows to determine appropriate irradiance values for the artificial light components.

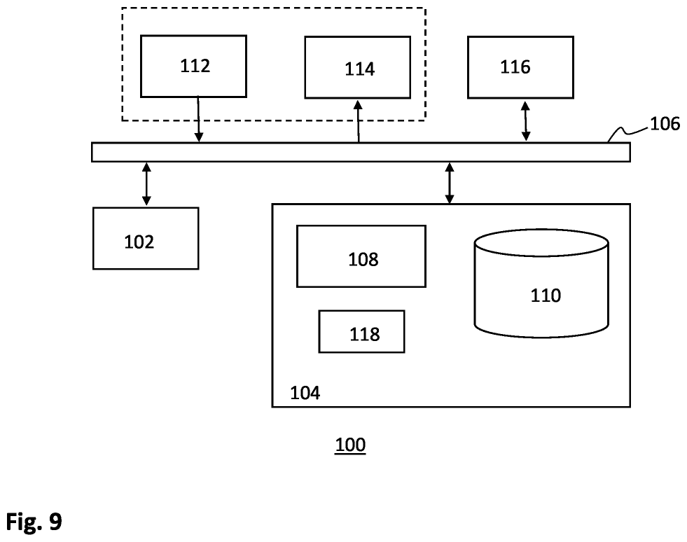

FIG. 9 depicts a block diagram illustrating a data processing system according to an embodiment.

As shown in FIG. 9, the data processing system 100 may include at least one processor 102 coupled to memory elements 104 through a system bus 106. As such, the data processing system may store program code within memory elements 104. Further, the processor 102 may execute the program code accessed from the memory elements 104 via a system bus 106. In one aspect, the data processing system may be implemented as a computer that is suitable for storing and/or executing program code. It should be appreciated, however, that the data processing system 100 may be implemented in the form of any system including a processor and a memory that is capable of performing the functions described within this specification.

Memory elements 104 may include one or more physical memory devices such as, for example, local memory 108 and one or more bulk storage devices 110. The local memory may refer to random access memory or other non-persistent memory device(s) generally used during actual execution of the program code. A bulk storage device may be implemented as a hard drive or other persistent data storage device. The processing system 100 may also include one or more cache memories (not shown) that provide temporary storage of at least some program code in order to reduce the number of times program code must be retrieved from the bulk storage device 110 during execution.

Input/output (I/O) devices depicted as an input device 112 and an output device 114 optionally can be coupled to the data processing system. Examples of input devices may include, but are not limited to, a keyboard, a pointing device such as a mouse, a touch-sensitive display, a sensor described herein, a control system of a greenhouse 100a, or the like. Examples of output devices may include, but are not limited to, a monitor or a display, speakers, an illumination system as described herein, or the like. Input and/or output devices may be coupled to the data processing system either directly or through intervening I/O controllers.

In an embodiment, the input and the output devices may be implemented as a combined input/output device (illustrated in FIG. 9 with a dashed line surrounding the input device 112 and the output device 114). An example of such a combined device is a touch sensitive display, also sometimes referred to as a “touch screen display” or simply “touch screen”. In such an embodiment, input to the device may be provided by a movement of a physical object, such as e.g., a stylus or a finger of a user, on or near the touch screen display.

A network adapter 116 may also be coupled to the data processing system to enable it to become coupled to other systems, computer systems, remote network devices, and/or remote storage devices through intervening private or public networks. The network adapter may comprise a data receiver for receiving data that is transmitted by said systems, devices and/or networks to the data processing system 100, and a data transmitter for transmitting data from the data processing system 100 to said systems, devices and/or networks. Modems, cable modems, and Ethernet cards are examples of different types of network adapter that may be used with the data processing system 100.

As pictured in FIG. 9, the memory elements 104 may store an application 118. In various embodiments, the application 118 may be stored in the local memory 108, the one or more bulk storage devices 110, or apart from the local memory and the bulk storage devices. It should be appreciated that the data processing system 100 may further execute an operating system (not shown in FIG. 9) that can facilitate execution of the application 118.

The application 118, being implemented in the form of executable program code, can be executed by the data processing system 100, e.g., by the processor 102. Responsive to executing the application, the data processing system 100 may be configured to perform one or more operations or method steps described herein.

In one aspect of the present invention, the data processing system 100 may represent a control system 100 as described herein.

In another aspect, the data processing system 100 may represent a client data processing system. In that case, application 118 may represent a client application that, when executed, configures the data processing system 100 to perform the various functions described herein with reference to a “client”. Examples of a client can include, but are not limited to, a personal computer, a portable computer, a mobile phone, or the like.

In yet another aspect, the data processing system 100 may represent a server. For example, the data processing system may represent an (HTTP) server, in which case the application 118, when executed, may configure the data processing system to perform (HTTP) server operations.

Various embodiments of the invention may be implemented as a program product for use with a computer system, where the program(s) of the program product define functions of the embodiments (including the methods described herein). In one embodiment, the program(s) can be contained on a variety of non-transitory computer-readable storage media, where, as used herein, the expression “non-transitory computer readable storage media” comprises all computer-readable media, with the sole exception being a transitory, propagating signal. In another embodiment, the program(s) can be contained on a variety of transitory computer-readable storage media. Illustrative computer-readable storage media include, but are not limited to: (i) non-writable storage media (e.g., read-only memory devices within a computer such as CD-ROM disks readable by a CD-ROM drive, ROM chips or any type of solid-state non-volatile semiconductor memory) on which information is permanently stored; and (ii) writable storage media (e.g., flash memory, floppy disks within a diskette drive or hard-disk drive or any type of solid-state random-access semiconductor memory) on which alterable information is stored. The computer program may be run on processor 102 described herein.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of embodiments of the present invention has been presented for purposes of illustration but is not intended to be exhaustive or limited to the implementations in the form disclosed. Many modifications and variations will be apparent to those of ordinary skill in the art without departing from the scope and spirit of the present invention. The embodiments were chosen and described in order to best explain the principles and some practical applications of the present invention, and to enable others of ordinary skill in the art to understand the present invention for various embodiments with various modifications as are suited to the particular use contemplated.

1. A computer-implemented method for controlling one or more luminaires that are configured to illuminate one or more plants with artificial light, the artificial light comprising a plurality of artificial light components, each of the artificial light components being of a respective wavelength or wavelength range, the plurality of artificial light components comprising a first artificial light component of a first wavelength or wavelength range and a second artificial light component of a second wavelength or wavelength range, the method comprising:
receiving a signal indicative of a non-spectrally resolved irradiance value of sunlight that is incident on the one or more plants,
determining, based on the non-spectrally resolved irradiance value, an irradiance value for the first artificial light component and an irradiance value for the second artificial light component,
storing sunlight reference data indicating, for each of a plurality of reference non-spectrally resolved irradiance values, a reference irradiance value for a first sunlight component and a reference irradiance value for a second sunlight component,
determining the irradiance value of the first artificial light component and determining the irradiance value of the second artificial light component based on the sunlight reference data, and
controlling the one or more luminaires such that they provide artificial light to the one or more plants having the determined irradiance value for the first artificial light component and the determined irradiance value for the second artificial light component, such that the one or more plants receive light of the first wavelength or wavelength range at a predefined irradiance value for the first wavelength or wavelength range and light of the second wavelength or wavelength range at a predefined irradiance value for the second wavelength or wavelength range.

2. The method according to claim 1, wherein receiving a signal indicative of a non-spectrally resolved irradiance value comprises measuring the non-spectrally resolved irradiance value of sunlight that is incident on the one or more plants.

3. The method according to claim 1, wherein,
determining the irradiance value for the first artificial light component comprises determining a difference between the reference irradiance value for the first sunlight component and the predefined irradiance value for the first wavelength or wavelength range; and/or
determining the irradiance value for the second artificial light component comprises determining a difference between the reference irradiance value for the second sunlight component and the predefined irradiance value for the second wavelength or wavelength range.

4. The method according to claim 1, wherein,
sunlight that is incident on the one or more plants has a first electromagnetic, EM, spectrum at a first time and a second EM spectrum at a second time after the first time, the second EM spectrum being different from the first EM spectrum, wherein
the received signal is indicative of the non-spectrally resolved irradiance value of the sunlight that is incident on the one or more plants at the first time, the method comprising:
receiving a second signal indicative of the non-spectrally resolved irradiance value of the sunlight that is incident on the one or more plants at the second time, and
determining, based on the second non-spectrally resolved irradiance value and the sunlight reference data, a reference irradiance value of the first sunlight component incident on the one or more plants at the second time, and a reference irradiance value of the second sunlight component incident on the one or more plants at the second time, and
based on a predefined irradiance value for the first wavelength or wavelength range at the second time and based on the determined reference irradiance value of the first sunlight component incident on the one or more plants at the second time, determining an irradiance value for the first artificial light component at the second time, and
based on a predefined irradiance value for the second wavelength or wavelength range at the second time and based on the determined reference irradiance value of the second sunlight component incident on the one or more plants at the second time, determining an irradiance value for the second artificial light component at the second time, and
controlling the one or more luminaires such that they provide artificial light to the one or more plants having the determined irradiance value for the first artificial light component at the second time and the determined irradiance value for the second artificial light component at the second time, such that the one or more plants receive, at the second time, light of the first wavelength or wavelength range at the predefined irradiance value for the first wavelength or wavelength range for the second time and light of the second wavelength or wavelength range at the predefined irradiance value for the second wavelength or wavelength range at the second time.

5. The method according to claim 4, wherein,
determining the irradiance value for the first artificial light component at the second time comprises determining a difference between the reference irradiance value for the first sunlight component at the second time and the predefined irradiance value for the first wavelength or wavelength range at the second time; and/or
determining the irradiance value for the second artificial light component at the second time comprises determining a difference between the reference irradiance value for the second sunlight component at the second time and the predefined irradiance value for the second wavelength or wavelength range at the second time.

6. The method according to claim 1, wherein,
storing sunlight reference data includes associating, with each of the plurality of reference non-spectrally resolved irradiance values, a month and a time of day.

7. The method according to claim 1, wherein the first wavelength range is between 400-500 nm and the second wavelength range is between 600-700 nm, or wherein the first wavelength range is between 600-700 nm and the second wavelength range is between 700-800 nm.

8. A control system for controlling one or more luminaires that are configured to illuminate one or more plants with artificial light, the artificial light comprising a plurality of artificial light components, each of the artificial light components being of a respective wavelength or wavelength range, the plurality of artificial light components comprising a first artificial light component of a first wavelength or wavelength range and a second artificial light component of a second wavelength or wavelength range, the control system comprising:
an input interface for receiving a signal indicative of a non-spectrally resolved irradiance value;
an output interface for sending an irradiance value for the first artificial light component and an irradiance value for the second artificial light component to an illumination device; and
a processor, wherein the processor is configured to;
receive a signal indicative of a non-spectrally resolved irradiance value of sunlight that is incident on the one or more plants,
determine, based on the non-spectrally resolved irradiance value, an irradiance value for the first artificial light component and an irradiance value for the second artificial light component,
store sunlight reference data indicating, for each of a plurality of reference non-spectrally resolved irradiance values, a reference irradiance value for a first sunlight component and a reference irradiance value for a second sunlight component,
determine the irradiance value of the first artificial light component and determining the irradiance value of the second artificial light component based on the sunlight reference data, and
control the one or more luminaires such that they provide artificial light to the one or more plants having the determined irradiance value for the first artificial light component and the determined irradiance value for the second artificial light component, such that the one or more plants receive light of the first wavelength or wavelength range at a predefined irradiance value for the first wavelength or wavelength range and light of the second wavelength or wavelength range at a predefined irradiance value for the second wavelength or wavelength range

9. An illumination system for illuminating one or more plants with artificial light, the illumination system comprising:
an illumination device that is configured to generate artificial light having a plurality of artificial light components, each of the artificial light components being of a respective wavelength or wavelength range, and configured to separately adjust irradiances of the respective light components, and
the control system according to claim 8.

10. A computer readable medium comprising instructions, the instructions when executed by a processor of an illumination device to perform the method according to claim 1.

11. (canceled)
